(19) United States
(12) Patent Application Publication
(10) Pub. No.: US 2014/0223293 A1
(43) Pub. Date: Aug. 7, 2014

(54) AUTOMATIC REPORT GENERATION IN A NETWORKED COMPUTING ENVIRONMENT

(71) Applicant: WISDOMAIN INC., (US)

(72) Inventors: Ilsoo Kim, Gyeonggi-do (KR); Seungho Jung, Gyeonggi-do (KR)

(73) Assignee: WISDOMAIN INC., Gyeonggi-do (KR)

(21) Appl. No.: 13/759,260

(22) Filed: Feb. 5, 2013

(51) Int. Cl. G06F 17/24

(52) U.S. Cl. CPC G06F 17/248
USPC 715/255

(57) ABSTRACT

An approach for automatically generating reports in a networked computing environment is provided. In a typical embodiment, the system will receive a set of unique identifiers associated with a set of IP assets and a set of input parameters in a computer memory medium. A (customizable) template will then be designated/selected for a report for the set of IP assets. The template will typically have at least one automatically generated portion and at least one manually generated portion. A set of IP documents corresponding to the set of IP assets will be identified using the set of unique identifiers. This allows information to be extracted from the set of IP documents. The template will then be populated (e.g., according to the input parameters) using the extracted information, a set of analysis content, and any manually provided content.

### TECHNICAL FIELD

Aspects of the present invention relate to automatic report generation. Specifically, the present invention relates to generation of analysis reports (e.g., from customizable templates) based on electronic documents such as patent documents according to user-defined parameters.

### BACKGROUND

As business competition has become more global, the capability to view technological trends of a specific industry (or to analyze technological competitiveness) has become highly critical. One manner of determining industry trends and/or competiveness is to view various online references such as patent documents. Specifically, patent documents (e.g., issued patents and/or published patent applications) are good indicators of industry trends and the directions in which competitors are shaping their product lines.

Unfortunately, analyzing sets of patent documents and collating the information into cohesive reports remains a time-consuming and manual process. For example, currently such report generation requires a user to manually review patent documents, generate components, make any manual additions, and then generate a report therefrom. Still yet, should the user desire to see statistical trend data (e.g., filing trends, fields of technology, etc.), the user must compile such information manually.

It is also difficult to provide a quantified evaluation of a particular IP asset and/or a comparison to competing or similar IP assets. Many variables factor into an IP asset's evaluation, one of which is the strength of the underlying filing/document. Previous attempts to provide such an evaluation involved one or more “experts” manually parsing the IP assets' documents and providing their subjective evaluations. Such an approach is not only time consuming, but also highly subjective and inconsistent (e.g., as different experts may evaluate things differently).

### SUMMARY

In general, embodiments of the present invention provide an approach for automatically generating reports in a networked computing environment. Specifically, in a typical embodiment, the system will receive a set of unique identifiers associated with a set of IP assets and a set of input parameters in a computer memory medium. A (customizable) template will then be designated/selected for a report for the set of IP assets. The template will typically have at least one automatically generated portion and at least one manually generated portion. Regardless, a set of IP documents corresponding to the set of IP assets will be identified using the set of unique identifiers. This allows information to be extracted from the set of IP documents. The template will then be populated (e.g., according to the input parameters) using the extracted information, a set of analysis content that is automatically generated based on an analysis of the set of IP documents, and any manually provided content. The populated template/report may then be edited as desired to yield a final report.

A first aspect of the present invention provides a computer-implemented method for generating reports for Intellectual Property (IP) assets in a networked computing environment, comprising: receiving a set of unique identifiers associated with a set of IP assets in a computer memory medium; designating a template for a report for the set of IP assets, the template having at least one automatically generated portion and at least one manually generated portion; receiving a set of input parameters for the report; identifying a set of IP documents corresponding to the set of IP assets using the set of unique identifiers; extracting information from the set of IP documents; populating, according to the input parameters, the template using the extracted information, a set of analysis content that is automatically generated based on an analysis of the set of IP documents, and any manually provided content; and performing any editing of the populated template to yield a final report.

A second aspect of the present invention provides a system for generating reports for Intellectual Property (IP) assets in a networked computing environment, comprising: a memory medium comprising instructions; a bus coupled to the memory medium; and a processor coupled to the bus that when executing the instructions causes the system to: receive a set of unique identifiers associated with a set of IP assets in a computer memory medium; designate a template for a report for the set of IP assets, the template having at least one automatically generated portion and at least one manually generated portion; receive a set of input parameters for the report; identify a set of IP documents corresponding to the set of IP assets using the set of unique identifiers; extract information from the set of IP documents; populate, according to the input parameters, the template using the extracted information, a set of analysis content that is automatically generated based on an analysis of the set of IP documents, and any manually provided content; and perform any editing of the populated template to yield a final report.

A third aspect of the present invention provides a computer program product for generating reports for Intellectual Property (IP) assets in a networked computing environment comprising a computer readable storage media, and program instructions stored on the computer readable storage media, to: receive a set of unique identifiers associated with a set of IP assets in a computer memory medium; designate a template for a report for the set of IP assets, the template having at least one automatically generated portion and at least one manually generated portion; receive a set of input parameters for the report; identify a set of IP documents corresponding to the set of IP assets using the set of unique identifiers; extract information from the set of IP documents; populate, according to the input parameters, the template using the extracted information, a set of analysis content that is automatically generated based on an analysis of the set of IP documents, and any manually provided content; and perform any editing of the populated template to yield a final report.

A fourth aspect of the present invention provides a method for deploying a system for generating reports in a networked computing environment, comprising: deploying a computer infrastructure being operable to: receive a set of unique identifiers associated with a set of IP assets in a computer memory medium; designate a template for a report for the set of IP assets, the template having at least one automatically generated portion and at least one manually generated portion; receive a set of input parameters for the report; identify a set of IP documents corresponding to the set of IP assets using the set of unique identifiers; extract information from the set of IP documents; populate, according to the input parameters, the template using the extracted information, a set of analysis content that is automatically generated based on an analysis of the set of IP documents, and any manually provided content; and perform any editing of the populated template to yield a final report.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing node according to an embodiment of the present invention.

FIG. 2 depicts an illustrative report according to an embodiment of the present invention.

FIG. 3 depicts a more detailed system diagram according to an embodiment of the present invention.

FIG. 4 depicts a method flow diagram according to an embodiment of the present invention.

FIG. 5 depicts a method flow diagram according to an embodiment of the present invention.

FIG. 6 depicts a method flow diagram according to an embodiment of the present invention.

FIG. 7 depicts the editing of a template and objects of a report according to an embodiment of the present invention.

FIG. 8 depicts the editing of a template and objects of a report according to an embodiment of the present invention.

FIG. 9 depicts the editing of a template and objects of a report according to an embodiment of the present invention.

FIG. 10 depicts the editing of a template and objects of a report according to an embodiment of the present invention.

FIG. 11 depicts the editing of a template and objects of a report according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The word “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

In general, embodiments of the present invention provide an approach for automatically generating reports in a networked computing environment. Specifically, in a typical embodiment, the system will receive a set of unique identifiers associated with a set of IP assets and a set of input parameters in a computer memory medium. A (customizable) template will then be designated/selected for a report for the set of IP assets. The template will typically have at least one automatically generated portion and at least one manually generated portion. Regardless, a set of IP documents corresponding to the set of IP assets will be identified using the set of unique identifiers. This allows information to be extracted from the set of IP documents. The template will then be populated (e.g., according to the input parameters) using the extracted information, a set of analysis content that is automatically generated based on an analysis of the set of IP documents, and any manually provided content. The populated template/report may then be edited as desired to yield a final report.

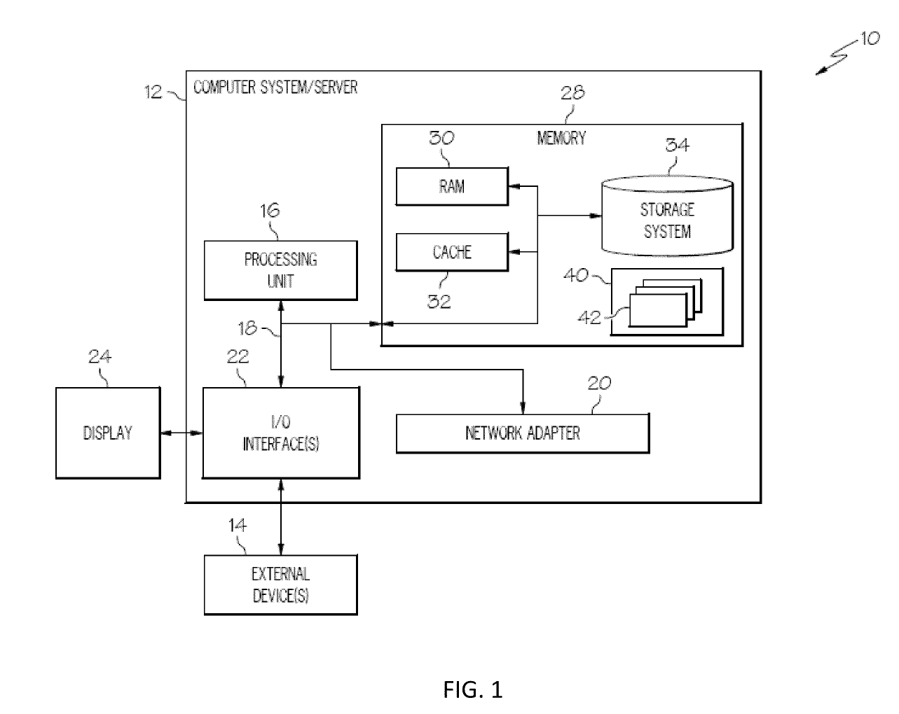

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin potential clients, thick potential clients, hand-held or laptop devices, mobile devices, global positioning systems (GPS), GPS-enabled devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on, that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each such media component can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. In general, program/utility 40 performs the function of the present invention as described herein. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

It is understood in advance that although the examples discussed herein and described in FIGS. 1-10 relate to patents, similar teachings could be applied to any type of IP asset such as trademarks, copyrights, trade secrets, know-how, show-how, etc.

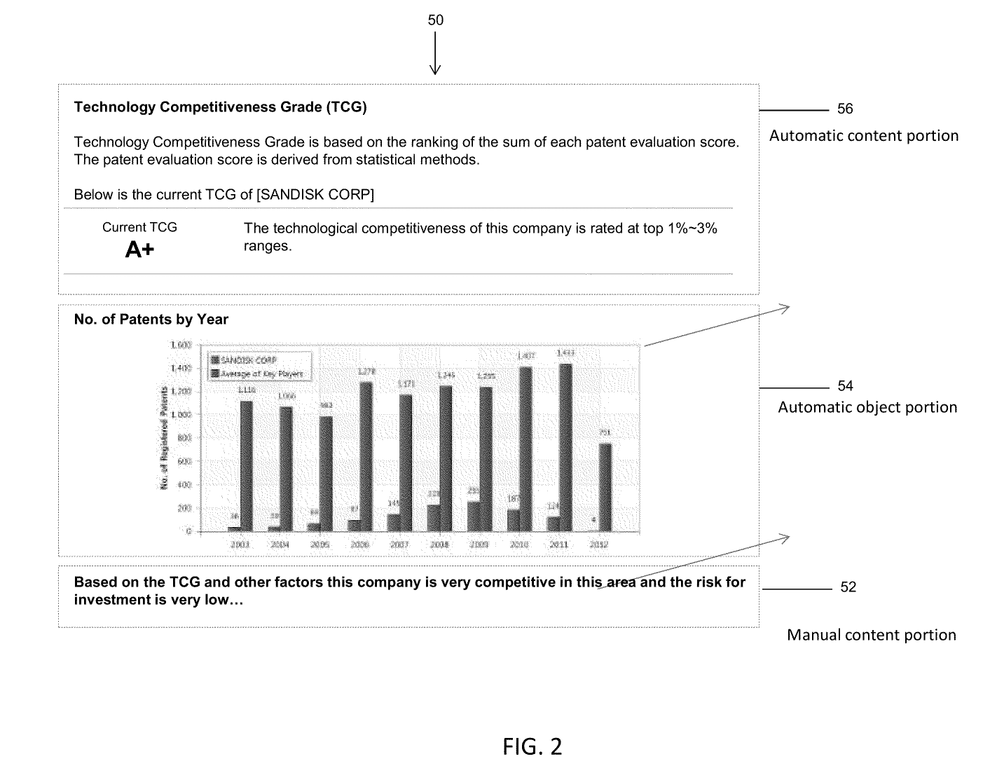

Referring to FIG. 2, a typical analysis report 50 according to an embodiment of the present invention is shown. As depicted, report 50 includes multiple components/portions: manual (e.g., human-generated) content portion 52, automatic content portion 56, and automatic object portion 54. Automatic content portion 56 can include predefined “report content” showing statistical results based on sets of patent data. Automatic object portion 54 can include “report objects” such as graphic charts, tables, indices, etc., showing statistical results based on sets of patent data. Manual content portion 52 can include content manually created by a user and can include any content the user deems necessary. Automatic content portion 56 and automatic object portion 54 are typically generated based on pre-set parameters. Such user-defined parameters can include (among other things) classification names, critical criteria values, type of charts, preset template for report, etc.

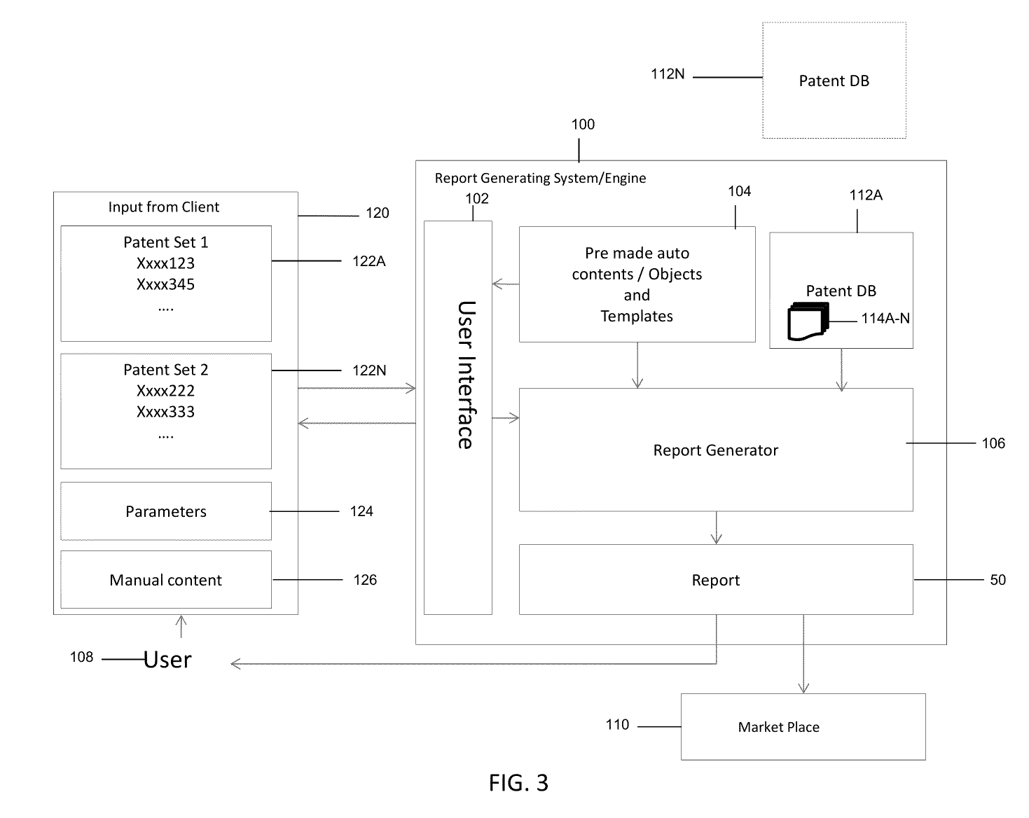

Referring now to FIG. 3, a system diagram describing the functionality discussed herein (and capable of generating a report such as report 50 shown in FIG. 2) according to an embodiment of the present invention is shown. It is understood that the teachings recited herein may be practiced within any type of networked computing environment (e.g., a cloud computing environment). A computer system/server 12 (FIG. 1), which can be implemented as either a stand-alone computer system or as a networked computer system can be utilized to implement report-generating system/engine 100. In the event the teachings recited herein are practiced in a networked computing environment, each potential client need not have an engine 100. Rather, engine 100 could be loaded on a server or server-capable device that communicates (e.g., wirelessly) with the potential clients to report generation functionality hereunder. In general, engine 100 can be implemented as program/utility 40 on computer system/server 12 of FIG. 1 and can enable the functions recited herein. As further shown, engine 100 (in one embodiment) comprises a rules and/or computational engine that processes a set (at least one) of rules/logic and/or provides report generation functionality hereunder.

As depicted, engine 100 typically comprises user interface 102, pre-made resources 104 (e.g., contents, objects, templates, etc.), report generator 106 that produces report 50 for user 108 and/or marketplace 110. As further shown, engine 100 may include or access a document (e.g., patent) database 112A from which electronic documents 114A-N are accessed, analyzed, and processed to yield report 50. As further shown, engine 100 may receive (via user interface 102) various types of user input 120 such as sets of unique identifiers/patent numbers 122A-N, input parameters 124 that designate the type of analysis to be conducted and/or the type of information that should be included in report 50 (e.g., a report “look and feel”, types of charts, types of “grades” (e.g., numbers, letters, etc.)), and manual/human content 126. Each of these user inputs 120 will be used by report generator 106 to: retrieve relevant electronic documents 114A-N from database(s) 112A-N; extract and/or analyze the information in electronic documents 114A-N; automatically generate any report content and/or report objects for report 50; and create report 50 with manual content 126, and automatic report contents/objects 104.

More specifically, engine 100 may perform multiple functions similar to a general-purpose computer. Specifically, among other functions, engine 100 may (among other things): receive a set of unique identifiers associated with a set of IP assets in a computer memory medium; designate a template for a report for the set of IP assets, the template having at least one automatically generated portion and at least one manually generated portion; optionally edit the template; receive a set of input parameters for the report; determine if the set of unique identifiers are in a correct format; determine if the set of input parameters are in a correct format; receive an optional designation of a hierarchy among the set of unique identifiers; identify a set of IP documents corresponding to the set of IP assets using the set of unique identifiers; extract information from the set of IP documents; analyze the set of IP documents; provide an evaluation of the set of IP assets based on the analysis of the set of IP documents (and optionally compare to other/competing IP assets/documents); populate, according to the input parameters, the template using the extracted information, a set of analysis content (e.g., statistical content (e.g., IP filing statistics) associated with the set of IP assets, evaluation content (e.g., grade(s) associated with the set of IP assets as compared to potentially competing IP assets associated with the set of IP assets, etc.) that is automatically generated based on the analysis of the set of IP documents and any manually provided content; and/or perform any editing of the populated template to yield a final report.

As indicated above, the report may include multiple portions/parts. Automatic content portion 56 may be selected based on a comparison of statistical results and the values of input parameters. That is, the underlying automatic content can be selected from one or more pre-written sets of content by the value of the input parameters and the statistical results. For example, assume that the value of an input parameter for “patent application growth ratio decision parameter”=“(3, 0.5).” Further assume that pre-written automatic content for “patent application growth ratio decision” are “investment in this area is sharply growing”, “investment in this area is stagnant,” and “investment in this area is sharply reducing.” After comparison with the statistical results of real patent application growth ratio and the input parameter “(3, 0.5)”: (1) if the statistical result is greater than “3.0,” then automatic content will be “investment in this area is sharply growing;” (2) if the statistical result is less than “0.5,” then automatic content will be “investment in this area is sharply reducing;” or (3) if the statistical result is in between those values, then the automatic content will be “investment in this area is stagnant.” Along similar lines, automatic object portion 54 may include charts, tables, indices, etc., showing statistical results based on sets of patent data. Similar to automatic content portion 56, automatic object portion 54 can be generated and/or edited based on the statistical results and/or the values of input parameters. Illustrative input parameters could be the type of charts (e.g., bar chart, line chart, etc.), the color of charts, the ranges of axis, etc.

As also indicated above, report 50 will be populated into a template or the like that may be modified (e.g., by the user 108). Such modification may be menu-driven and/or tags-based. Shown below are examples of a tags-based approach:

[Human content start] . . . [Human content end];

[Automatic content start] autocontent1 with patent set1 with parameter1:value1, parameter2:value2, parameter3:value3 . . . [Automatic content end]; and

[Automatic object start] autoobject1 with patent set 1 with parameter1:value1, parameter2:value2, parameter3:value3 . . . [Automatic object end].

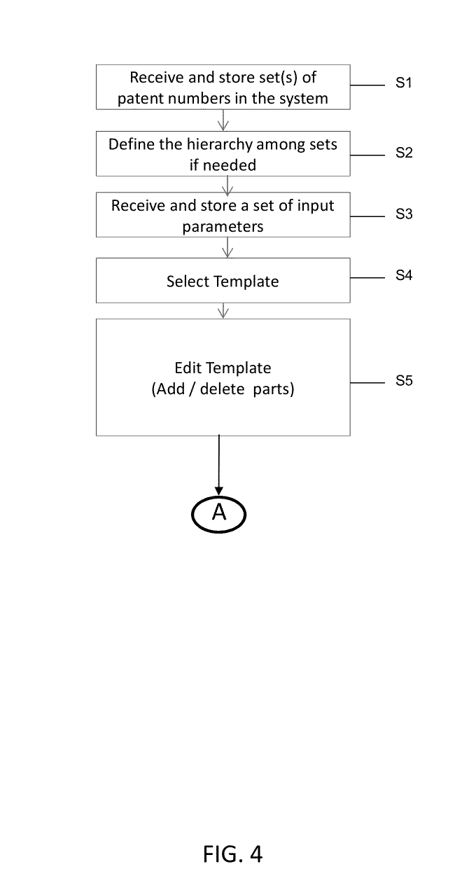

Referring to FIGS. 4-6, method flow diagrams describing the above functionality are shown. It is reiterated that although the illustrative example described herein refers to “patents” and “patent numbers,” similar concepts may be applied to any type of IP asset. Referring first to FIG. 4, steps involved with providing input used to generate report 50 are shown. As depicted in step S1, sets of patent numbers are received and stored. In step S2, a hierarchy among the patent numbers is optionally defined (e.g., to better prioritize the corresponding patent documents in the resulting report). In step S3, input parameters are received. In step S4 a template is selected, and in step S5, the selected template may be edited.

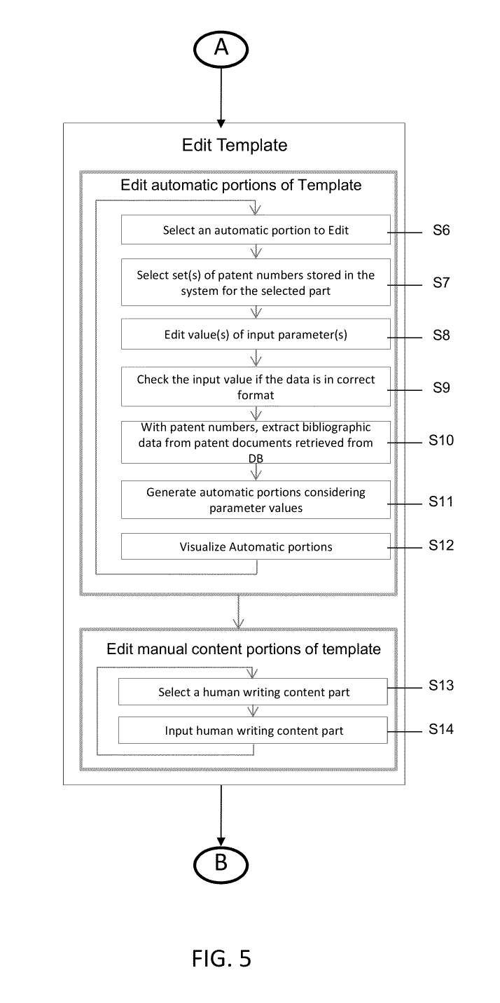

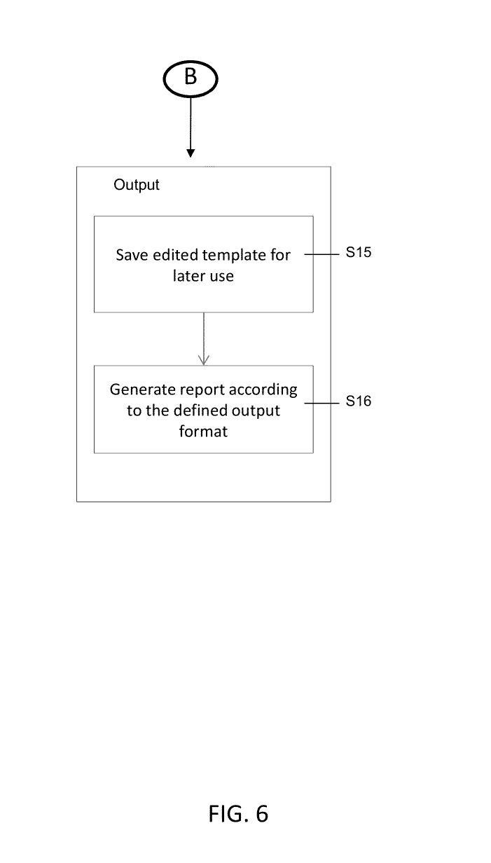

Referring now to FIG. 5, the steps involved with editing the template and/or report (e.g., “report content” and/or “report objects”) are shown. In step S6, an automatic portion (e.g., content or object) of the template/initial report is selected for editing. Is step S7, sets of patent numbers stored in the system for the selected portion are selected. In step S8, values of input parameters are edited. In step S9, it is determined whether the input parameters are in the correct format (and corrected if not). In step S10, information (e.g., bibliographic data) is extracted from patent documents retrieved from the database(s) using the patent numbers. In step S11, the automatic portions of the report are generated based on the input parameter values. In step S12, the automatic portions (content and object portions) are “visualized.” The process may continue with the editing of the manual content portions. Specifically, a particular piece of the manual content portion is selected in step S13, and then edited in step S14. It is understood that the order in which the automatic portions (content and object) and the manual portion are edited need not be limiting. For example, a user could have edited the manual content portion first. Regardless, the process is then continued in FIG. 6 in which the edited template/report are saved for later use in step S15, and a final report is generated in step S16 based on the newly defined output format.

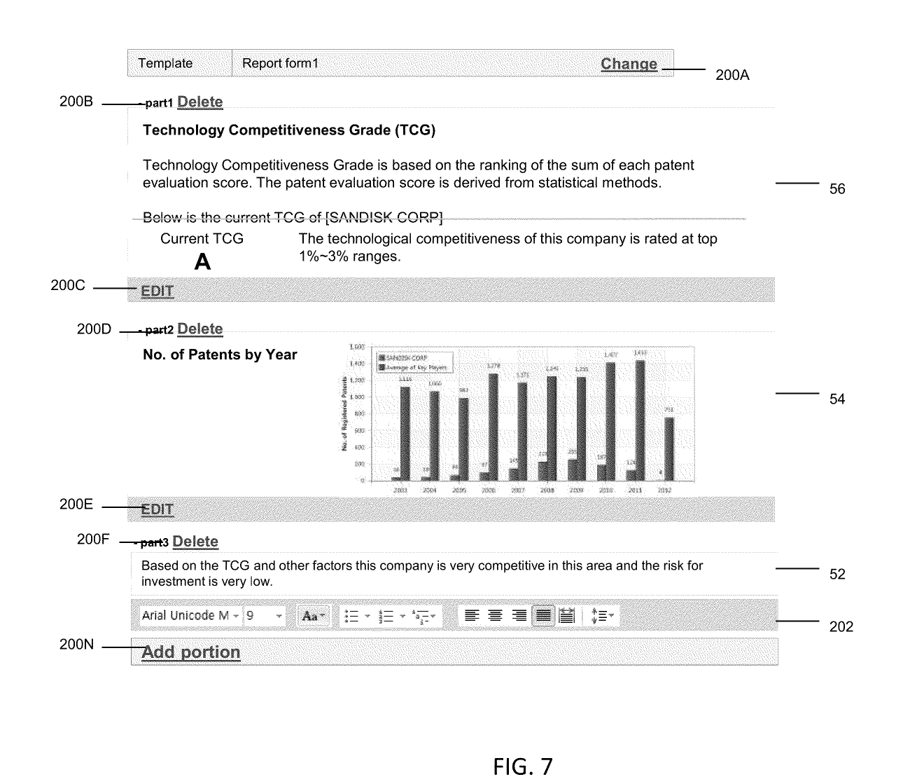

Referring now to FIG. 7, an example of template editing functionality is shown. As depicted, an interface or the like may be provided that includes various buttons 200A-N that allow each portion 52, 54, and/or 56 to be individually edited. A text editing function 202 may also be provided for editing and/or formatting any manually generated text.

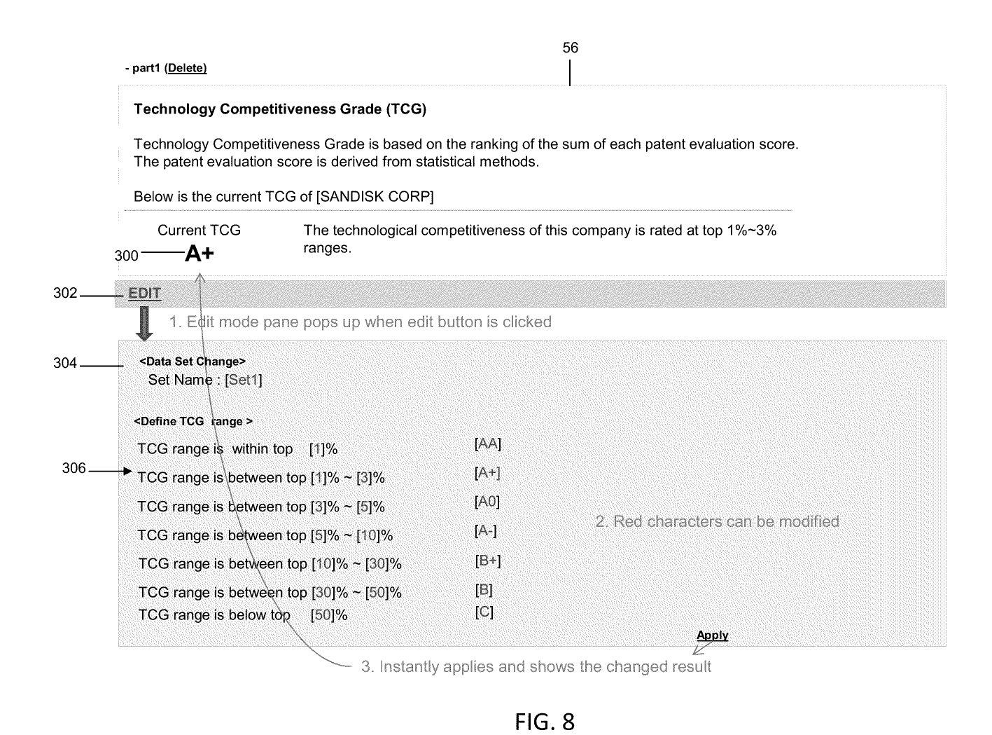

FIG. 8 depicts the editing of the automatic content portion 56 of a report/template. Specifically, as shown, a technology competitiveness grade (TCG) 300 is depicted. TCG 300 is typically computed by engine 100 using predetermined algorithms and/or measurement criteria. In general, TCG 300 represents where a company is positioned with respect to its competitors based on the strength (or weakness) of its IP portfolio (e.g., as identified by the company's patent numbers as input as described herein). The grade can be computed based upon any number of factors such as the number of patent filings or issuances, the variety of technology areas in which patents are filed or issued, the quality of the filing or issued patent, the scope of the underlying claims, etc. In any event, TCG 300 is typically assigned based on a predetermined sliding scale. Such TCG 300 and/or scale may be edited hereunder. As shown, a user may select edit button 302 to cause edit window/pane 304 to be displayed. Once displayed, a user may interact with edit window 304 to change the consent 306 thereof such as the sliding scale or the TCG 300 associated therewith. These changes may be saved by selecting “apply” button 308.

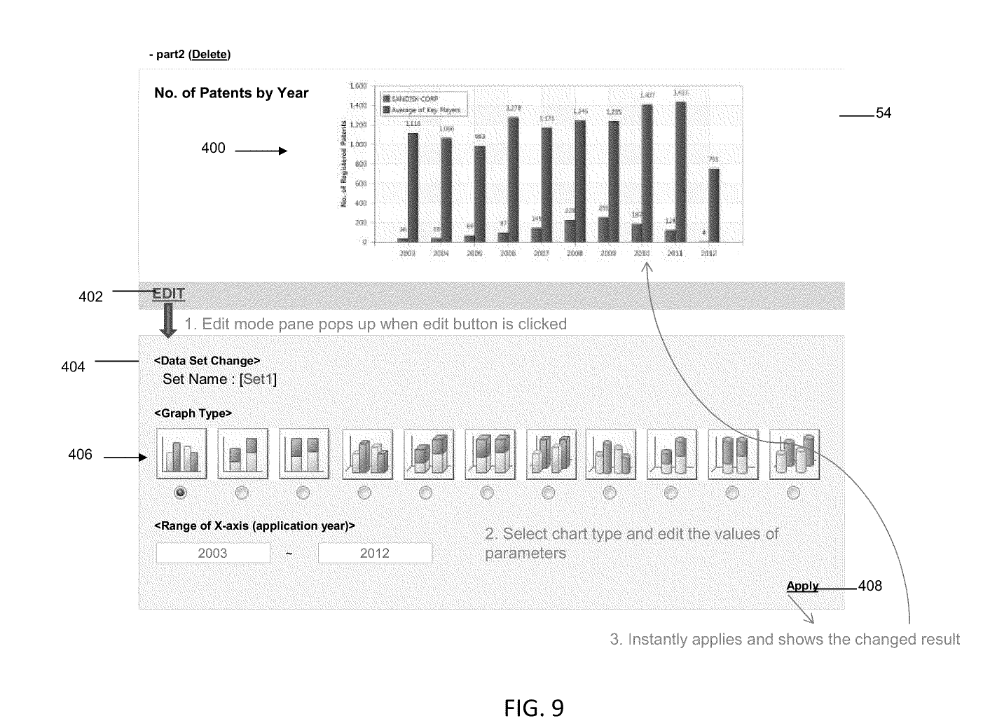

FIG. 9 depicts a similar concept in conjunction with the editing of the automatic object portion 54 of a report/template. Specifically, as shown, a graph 400 is shown. Graph 400 is typically computed by engine 10 using predetermined statistics and/or measurement criteria. As such, graph 400 can be computed based upon any number of factors such as the number of patent filings or issuances, etc. As shown, a user may select edit button 402 to cause edit window/pane 404 to be displayed. Once displayed, a user may interact with edit window 404 to change the objects 406 such as the type of graph to be displayed. These changes may be saved by selecting “apply” button 408.

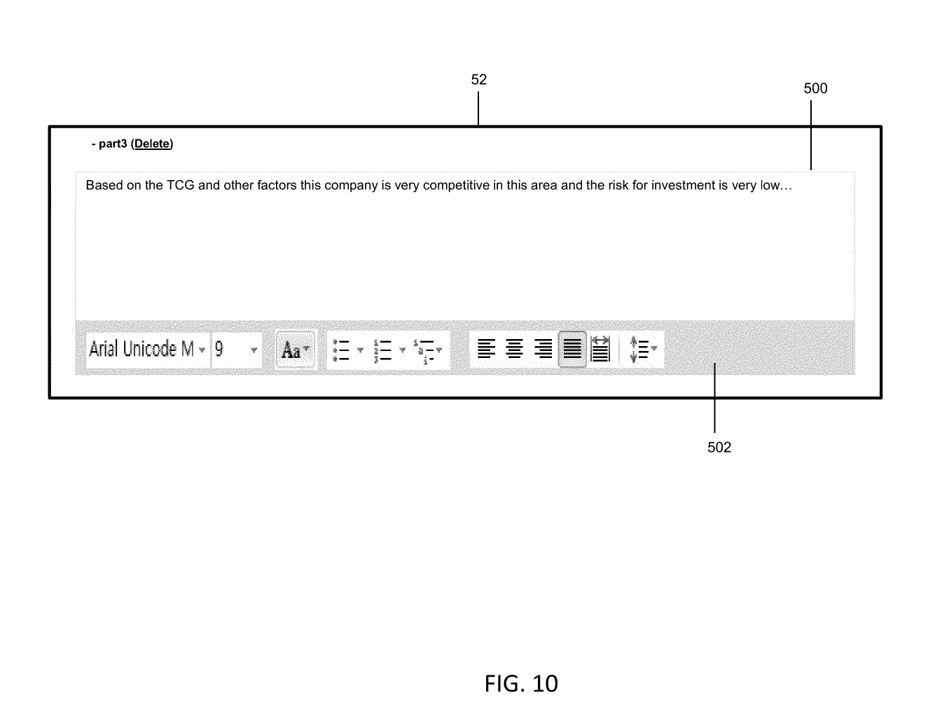

FIG. 10 depicts a similar concept in conjunction with the editing of manual content portion 52 of a report/template. As depicted, when a user wishes to edit manual content, the user can do so via edit window/pane 500. AS depicted, user can manually input, modify or change text using input devices and edit option bar 502.

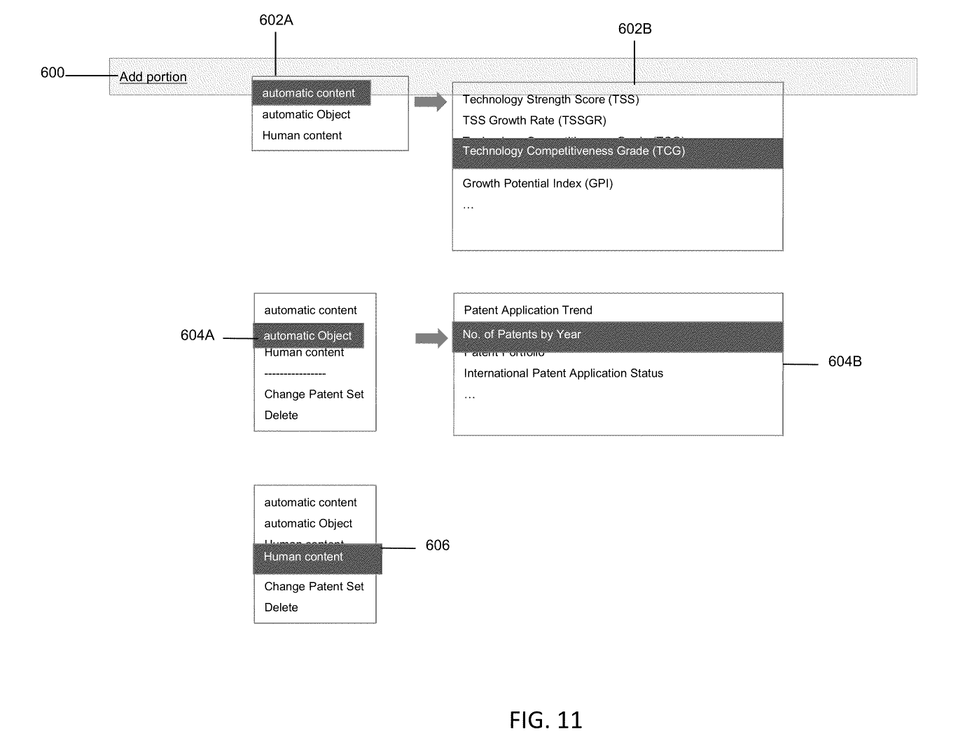

FIG. 11 shows a series of interfaces/menus/functions for a user to add additional automatic content, automatic objects, and/or manual content to a template/report. For example, a user may want more than one TCG, graph, statement, etc., to appear in a final report. As such, the user can select button 600 to reveal one or more menus. Menu selection 602A for automatic content addition will result in option menu 602B being displayed, menu selection 604A for automatic objection addition will result in option menu 604B being displayed, while menu selection 606 for manual content addition will result in an edit window such as window 500 of FIG. 10 being displayed.

As such, the system/engine described herein allows for a robust and complete report generation system that allows for various types of content to be displayed, edited, and/or presented.

While shown and described herein as a report generation solution, it is understood that the invention further provides various alternative embodiments. For example, in one embodiment, the invention provides a computer-readable/useable medium that includes computer program code to enable a computer infrastructure to provide a report generation as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide report generation functionality. In this case, the service provider can create, maintain, support, etc., a computer infrastructure, such as computer system/server 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for a report generation. In this case, a computer infrastructure, such as computer system 12/server (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A computer-implemented method for generating reports for Intellectual Property (IP) assets in a networked computing environment, comprising:
receiving a set of unique identifiers associated with a set of IP assets in a computer memory medium;
designating a template for a report for the set of IP assets, the template having at least one automatically generated portion and at least one manually generated portion;
receiving a set of input parameters for the report;
identifying a set of IP documents corresponding to the set of IP assets using the set of unique identifiers;
extracting information from the set of IP documents;
populating, according to the input parameters, the template using the extracted information, a set of analysis content that is automatically generated based on an analysis of the set of IP documents, and any manually provided content; and
performing any editing of the populated template to yield a final report.

2. The computer-implemented method of claim 1, the set of analysis content comprising at least one of the following: statistical content associated with the set of IP assets, or evaluation content associated with the set of IP assets.

3. The computer-implemented method of claim 2, the statistical content comprising IP filing statistics.

4. The computer-implemented method of claim 2, the evaluation content comprising at least one grade associated with the set of IP assets as compared to potentially competing IP assets.

5. The computer-implemented method of claim 1, further comprising determining if the set of unique identifiers are in a correct format.

6. The computer-implemented method of claim 1, further comprising receiving a designation of a hierarchy among the set of unique identifiers.

7. The computer-implemented method of claim 1, further comprising determining if the set of input parameters are in a correct format.

8. The computer-implemented method of claim 1, further comprising editing the template prior to the populating.

9. A system for generating reports for Intellectual Property (IP) assets in a networked computing environment, comprising:
a memory medium comprising instructions;
a bus coupled to the memory medium; and
a processor coupled to the bus that when executing the instructions causes the system to:
receive a set of unique identifiers associated with a set of IP assets in a computer memory medium;
designate a template for a report for the set of IP assets, the template having at least one automatically generated portion and at least one manually generated portion;
receive a set of input parameters for the report;
identify a set of IP documents corresponding to the set of IP assets using the set of unique identifiers;
extract information from the set of IP documents;
populate, according to the input parameters, the template using the extracted information, a set of analysis content that is automatically generated based on an analysis of the set of IP documents, and any manually provided content; and
perform any editing of the populated template to yield a final report.

10. The system of claim 9, the set of analysis content comprising at least one of the following: statistical content associated with the set of IP assets, or evaluation content associated with the set of IP assets.

11. The system of claim 10, the statistical content comprising IP filing statistics.

12. The system of claim 10, the evaluation content comprising at least one grade associated with the set of IP assets as compared to potentially competing IP assets.

13. The system of claim 9, the memory medium further comprising instructions for causing the system to determine if the set of unique identifiers are in a correct format.

14. The system of claim 9, the memory medium further comprising instructions for causing the system to receive a designation of a hierarchy among the set of unique identifiers.

15. The system of claim 9, the memory medium further comprising instructions for causing the system to determine if the set of input parameters are in a correct format.

16. The system of claim 9, the memory medium further comprising instructions for causing the system to edit the template prior to the populating.

17. A computer program product for generating reports for Intellectual Property (IP) assets in a networked computing environment comprising a computer readable storage media, and program instructions stored on the computer readable storage media, to:
receive a set of unique identifiers associated with a set of IP assets in a computer memory medium;
designate a template for a report for the set of IP assets, the template having at least one automatically generated portion and at least one manually generated portion;
receive a set of input parameters for the report;
identify a set of IP documents corresponding to the set of IP assets using the set of unique identifiers;
extract information from the set of IP documents;
populate, according to the input parameters, the template using the extracted information, a set of analysis content that is automatically generated based on an analysis of the set of IP documents, and any manually provided content; and
perform any editing of the populated template to yield a final report.

18. The computer program product of claim 17, the set of analysis content comprising at least one of the following: statistical content associated with the set of IP assets, or evaluation content associated with the set of IP assets.

19. The computer program product of claim 18, the statistical content comprising IP filing statistics.

20. The computer program product of claim 18, the evaluation content comprising at least one grade associated with the set of IP assets as compared to potentially competing IP assets.

21. The computer program product of claim 17, the computer readable storage media further comprising instructions to determine if the set of unique identifiers are in a correct format.

22. The computer program product of claim 17, the computer readable storage media further comprising instructions to receive a designation of a hierarchy among the set of unique identifiers.

23. The computer program product of claim 17, the computer readable storage media further comprising instructions to determine if the set of input parameters are in a correct format.

24. The computer program product of claim 17, the computer readable storage media further comprising instructions to edit the template prior to the populating.

25. A method for deploying a system for generating reports in a networked computing environment, comprising:
deploying a computer infrastructure being operable to:
receive a set of unique identifiers associated with a set of IP assets in a computer memory medium;
designate a template for a report for the set of IP assets, the template having at least one automatically generated portion and at least one manually generated portion;
receive a set of input parameters for the report;
identify a set of IP documents corresponding to the set of IP assets using the set of unique identifiers;
extract information from the set of IP documents;
populate, according to the input parameters, the template using the extracted information, a set of analysis content that is automatically generated based on an analysis of the set of IP documents, and any manually provided content; and
perform any editing of the populated template to yield a final report.
